(19) United States
(12) Patent Application Publication
(10) Pub. No.: US 2006/0290994 A1
(43) Pub. Date: Dec. 28, 2006

(54) Electrostatic recording medium having reading-side photoconductive layer of inorganic oxide

(75) Inventor: Kiyoteru Miyake, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/474,345

(22) Filed: Jun. 26, 2006

(30) Foreign Application Priority Data
Jun. 24, 2005 (JP) 185110/2005

(51) Int. Cl. H04N 1/29

(52) U.S. Cl. 358/300

(57) ABSTRACT

An electrostatic recording medium includes: a first conductive layer which is transparent to radiation for recording; a recording-side photoconductive layer which is formed above the first conductive layer and becomes conductive when the recording-side photoconductive layer is exposed to the radiation for recording; a charge-accumulation region which is formed above the recording-side photoconductive layer and accumulates electric charges being generated in the recording-side photoconductive layer and having a latent polarity; a reading-side photoconductive layer which is formed of inorganic oxide above the charge-accumulation region and becomes conductive when the reading-side photoconductive layer is exposed to an electromagnetic wave for reading; and a second conductive layer which is formed above the reading-side photoconductive layer and transparent to the electromagnetic wave for reading.

### BACKGROUND OF THE INVENTION

1. Field of the Invention

The present invention relates to an electrostatic recording medium which can record as image information an electrostatic charge pattern (an electrostatic latent image) formed by exposure to radiation such as X-rays.

2. Description of the Related Art

Conventionally, image recording mediums using a photoconductor sensitive to radiation are widely used in medical radiography for reduction of the exposure doses which subjects receive, improvement of diagnostic performance, and the like. When an image recording medium as above is irradiated with radiation, latent charges corresponding to the exposure dose of the radiation are accumulated in the image recording medium. Thereafter, the radiation image can be read out from the image recording medium by detecting the accumulated latent charges.

For example, U.S. Pat. No. 6,268,614 discloses an electrostatic recording medium having a triple-layered structure in which a charge-transport layer behaving as a conductor of only positive charges is sandwiched between a recording-side photoconductive layer and a reading-side photoconductive layer, where the triple-layered structure is further sandwiched between conductive layers. The electrostatic recording medium is arranged to be able to record image information in the form of an electrostatic latent image by accumulating electric charges at the interface between the recording-side photoconductive layer and the charge-transport layer. In the above electrostatic recording medium, an electrostatic latent image can be recorded only by electrifying the conductive layers so as to be held at predetermined potentials and irradiating the recording-side photoconductive layer with radiation for recording. That is, it is unnecessary to preliminarily electrify the electrostatic recording medium by uniformly irradiating the electrostatic recording medium in advance to recording. Therefore, provision for the uniform irradiation is unnecessary, so that it is possible to simplify the image recording system. Further, the offset effect of the dark-current electrons on the latent charges generated by the radiation for recording can be suppressed, so that it is possible to realize a high-SNR (signal-to-noise ratio) image recording system.

For example, U.S. Pat. No. 6,268,614 discloses, as materials preferable for the reading-side photoconductive layer in the electrostatic recording medium, amorphous selenium (a-Se), PbI₂, metal-free phthalocyanine, metallo-phthalocyanines, Bi₁₂(Ge, Si)O₂₀, and perylene bis-imides (where R=n-propyl or R=n-neopentyl).

However, use of the above materials has the followig problems.

(1) The light absorption in selenium occurs in the blue wavelength range, and therefore the options for the light for reading are narrow. (Hereinafter, the light for reading is referred to as reading light.)

(2) Since the charge mobility in the amorphous materials such as a-Se is considerably lower than in the crystalline materials, responsiveness in detection of charges by application of reading light is poor. Therefore, when the scanning speed is increased for fast reading (i.e., in the fast reading mode), the amount of detected charges becomes small, so that it is impossible to obtain high-quality images. On the other hand, when the scanning speed is decreased in order to obtain high-quality images (i.e., in the high-quality mode), it takes long time to read the images, although the amount of detected charges increases and therefore the quality of the images is improved.

(3) In the case where the metal iodides such as HgI₂, PbI₂, or BiI3 are used, high dark current occurs, so that background noise increases.

(4) Although phthalocyanines allow wide options for the absorbed light, the charge mobility is low, and the response is slow.

(5) Although the charge mobility in Bi₁₂(Ge, Si)O₂₀ is higher than in selenium, the charge lifetime is so short that the product of the charge mobility and the charge lifetime becomes small. Therefore, use of Bi₁₂(Ge, Si)O₂₀ is disadvantageous in charge collection.

(6) Perylene bis-imides have similar problems to phthalocyanines.

In order to solve the above problems, U.S. Patent Application Publication No. 20040086204 discloses an image reading system using a solid-state detector which includes a reading-side photoconductive layer formed of amorphous material. The disclosed image reading system enables selective use in either of the fast reading mode and the high-quality mode.

The image reading system disclosed in U.S. Patent Application Publication No. 20040086204 is proposed for solving the problem of the charge mobility in the amorphous materials and the problem of the responsiveness in detection of charges by application of reading light, by enabling selective use in either of the fast reading mode and the high-quality mode. However, the materials per se are not considered in U.S. Patent Application Publication No. 20040086204. Therefore, the technique disclosed in U.S. Patent Application Publication No. 20040086204 does not solve the problems of the materials for the reading-side photoconductive layer at the root.

### SUMMARY OF THE INVENTION

The present invention has been made in view of such circumstances.

The object of the present invention is to provide an electrostatic recording medium which includes a reading-side photoconductive layer exhibiting high responsiveness in detection of charges by application of reading light, and in which no substantial reduction occurs in sharpness even in the fast reading mode.

In order to accomplish the above object, according to the present invention, an electrostatic recording medium for recording an electrostatic latent image is provided. The electrostatic recording medium according to the present invention comprises: a first conductive layer which is transparent to radiation for recording; a recording-side photoconductive layer which is formed above the first conductive layer and becomes conductive when the recording-side photoconductive layer is exposed to the radiation for recording; a charge-accumulation region which is formed above the recording-side photoconductive layer and accumulates electric charges being generated in the recording-side photoconductive layer and having a latent polarity; a reading-side photoconductive layer which is formed of inorganic oxide above the charge-accumulation region and becomes conductive when the reading-side photoconductive layer is exposed to an electromagnetic wave for reading; and a second conductive layer which is formed above the reading-side photoconductive layer and transparent to the electromagnetic wave for reading.

In the above electrostatic recording medium, the reading-side photoconductive layer formed of inorganic oxide should not substantially contain material other than the inorganic oxide. However, the reading-side photoconductive layer may contain impurities which are unavoidably included in the reading-side photoconductive layer during production.

In the electrostatic recording medium according to the present invention, the charge mobility in the reading-side photoconductive layer is great, and therefore the responsiveness in detection of charges by application of reading light is high. Thus, according to the present invention, it is possible to realize an electrostatic recording medium in which no substantial reduction occurs in sharpness even in the fast reading mode.

Preferably, the inorganic oxide forming the reading-side photoconductive layer is binary oxide. The binary oxide means the oxide consisting of oxygen and at least one of metal elements such as Ti, Ga, Bi, Zr, Zn, Nb, Sn, In, Ta, V, Pb, Fe, Cu, Gd, Ce, Y, W, or La. More preferably, the binary oxide is zinc oxide.

The use of zinc oxide as the inorganic oxide in the reading-side photoconductive layer is advantageous as follows.

(a) Since zinc oxide has no toxicity, provision of the recovery line or the like for zinc oxide in the manufacturing process is unnecessary. Therefore, the use of zinc oxide reduces the manufacturing cost.

(b) Since the charge mobility is great, it is unnecessary to apply high voltage to the electrostatic recording medium.

(c) Since the response is fast, no substantial reduction occurs in sharpness even in the fast reading mode.

(d) In the case where the purity of the raw material of zinc oxide is high, it is possible to make the reading-side photoconductive layer close to an intrinsic semiconductor. Therefore, it is possible to realize high electric resistance and suppress dark current in the electrostatic recording medium.

Generally, inorganic oxide can be spectrally sensitized. In the electrostatic recording medium according to the present invention, the inorganic oxide forming the reading-side photoconductive layer may be dye-sensitized. The dye sensitization is the sensitization realized by dye absorption for the purpose of extension of the sensitive wavelength range to the longer wavelength side. Thus, it is possible to use as the reading light visible light or infrared light as well as ultraviolet light.

### DESCRIPTION OF THE DRAWINGS

FIG. 1 is a cross-sectional view schematically illustrating an electrostatic recording medium according to an embodiment of the present invention.

FIG. 2 is a schematic diagram of a recording-and-reading system for recording an electrostatic latent image in the electrostatic recording medium of FIG. 1 and reading the electrostatic latent image from the electrostatic recording medium.

FIGS. 3A, 3B, 3C and 3D are diagrams illustrating electric charges in respective stages in a process for recording an electrostatic latent image in the system of FIG. 2.

FIGS. 4A, 4B, 4C and 4D are diagrams illustrating electric charges in respective stages in a process for reading an electrostatic latent image in the system of FIG. 2.

### DESCRIPTION OF PREFERRED EMBODIMENTS

Inorganic Oxide

As mentioned in the “SUMMARY OF THE INVENTION,” the electrostatic recording medium according to the present invention comprises the first conductive layer, the recording-side photoconductive layer, the charge-accumulation region, the reading-side photoconductive layer, and the second conductive layer. In particular, the reading-side photoconductive layer is formed of inorganic oxide, which is preferably binary oxide, and more preferably zinc oxide (ZnO).

Specifically, particles of the zinc oxide can be produced by either wet or dry processes. For example, the wet processes include the following processes (a1) and (a2).

(a1) In the first wet process, zinc basic carbonate is produced by adding sodium carbonate to aqueous solution of zinc sulfate or zinc chloride, washed with water, dried, and prebaked. This process is called the German process.

(a2) In the second wet process, zinc hydroxide is obtained by recovery of zinc metal, washed with water, dried, and prebaked.

For example, the wet processes for producing zinc oxide particles are indicated by Takeuchi et al. in Electrophotography (The Journal of the Imaging Society of Japan), Vol. 23, No. 4 (1984), pp. 213-221.

In addition, examples of the dry processes include the following processes (b1) and (b2).

(b1) In the first dry process, molten zinc metal is heated to 1,000° C. in a retort so as to generate zinc vapor, and the zinc vapor is oxidized with air. This process is called the indirect process or the French process.

(b2) In the second dry process, zinc sulfide (ZnS) is roasted with a reducing agent so as to generate zinc vapor, and the zinc vapor is oxidized with air. This process is called the direct process or the American process.

From the viewpont of purity, the French process is most preferable.

The reading-side photoconductive layer can be formed by using any of the known techniques as appropriate. For example, the known techniques include sputtering (as indicated in Japanese Unexamined Patent Publication No. 2001-22110, which is hereinafter referred to as JPP 2001-22110), CVD (Chemical Vapor Deposition), PVD (Plasma Vapor Deposition), the electrolytic process (as indicated in JPP 2001-22110), ion plating, pulsed-laser evaporation, spray thermal decomposition (as indicated in Japanese Unexamined Patent Publications Nos. 2001-22110 and 2000-227670), application, the sol-gel process (as indicated in Japanese Unexamined Patent Publication No. 5-294622), the technique for forming a sintered porous film (as indicated in Japanese Unexamined Patent Publication No. 2000-162799), and aerosol deposition. In the case where the reading-side photoconductive layer is formed by application, although any appropriate material can be used as the binder in a suspension of particles, polyester-based polymer and silicon resin are preferable for the binder.

The inorganic oxide forming the reading-side photoconductive layer may be dye-sensitized. The dye sensitizer may be chosen as appropriate, for example, from phthalocyanine dyes such as the metal-free phthalocyanine dye, the aluminum phthalocyanine (Al—Pc) dye, the titanyl phthalocyanine (TiO—Pc) dye, the cobalt phthalocyanine (Co—Pc) dye, the copper phthalocyanine (Cu—Pc) dye, and the tin phthalocyanine (Sn—Pc) dye, rose bengal, bromophenol blue, eosine, rhodamine, the xanthene-based dyes, the phenolsulfonphthalein-based dyes, the thiazine-based dyes, the triphenylmethane-based dyes, the acridine dyes, the cyanine-based dyes, the merocyanine dye, the squarylium dye, and the metallic complex dyes such as the ruthenium complex dyes.

In order to dye-sensitize the inorganic oxide, the dye sensitizer is absorbed in the gaps between the sintered inorganic oxide particles, or the gaps are filled with the dye sensitizer. Specifically, dye sensitization can be performed by the following techniques (c1) to (c3).

(c1) In the first technique, sintered inorganic oxide is soaked in a solution of the dye sensitizer for a predetermined time, and is then lifted out of the solution. Thereafter, the solvent is removed from the sintered inorganic oxide by evaporation.

(c2) In the second technique, the dye sensitizer is directly sublimated onto sintered inorganic oxide.

(c3) In the third technique, a solution of the dye sensitizer is added to a suspension of zinc oxide particles.

Electrostatic Recording Medium

There are two types of electrostatic recording mediums. One is the direct-conversion type, which directly converts radiation into electric charges and accumulates the electric charges. The other is the indirect conversion type, which converts radiation into light with a scintillator such as CsI, further converts the light into electric charges with a-Si (amorphous silicon) photodiodes, and accumulates the electric charges. The electrostatic recording medium according to the present invention are the direct-conversion type, and is sensitive to radiation including X-rays, gamma rays, alpha rays, beta rays, and the like.

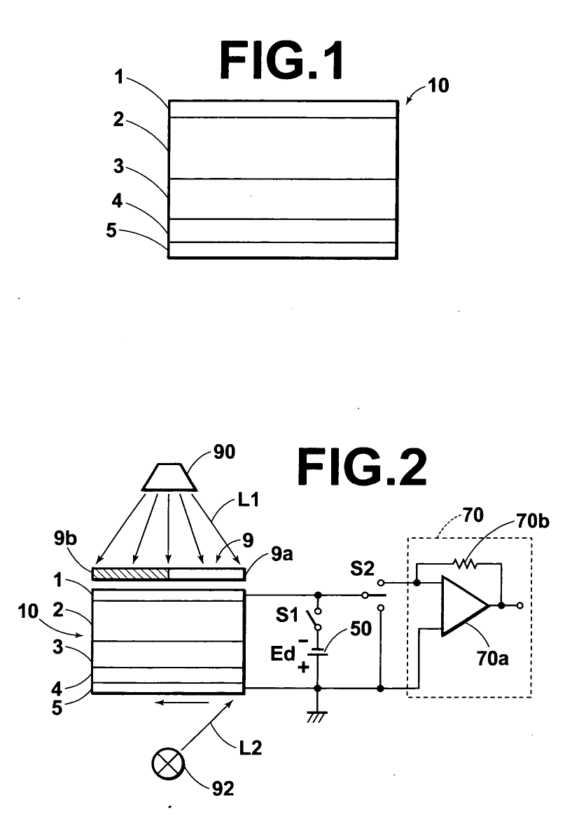

FIG. 1 is a cross-sectional view schematically illustrating an electrostatic recording medium according to an embodiment of the present invention.

The electrostatic recording medium 10 of FIG. 1 is constituted by forming a first transparent conductive layer 1, a recording radioconductive layer 2, a charge-transport layer 3, a reading photoconductive layer 4, and a second transparent conductive layer 5 in this order. The first transparent conductive layer 1 is transparent to radiation L1 for recording (which is explained later). The recording radioconductive layer 2 becomes conductive in response to exposure to the radiation L1 which has passed through the first transparent conductive layer 1. The charge-transport layer 3 substantially behaves as an insulator against first electric charges with which the first transparent conductive layer 1 is electrified (e.g., latent-image polarity charges, for example, the negative charges), and substantially behaves as a conductor of second electric charges having a polarity opposite to the first electric charges (transport polarity charges, for example, the positive charges in the case where the latent-image polarity is negative). The reading photoconductive layer 4 (corresponding to the aforementioned reading-side photoconductive layer in the electrostatic recording medium according to the present invention) becomes conductive in response to exposure to the light L2 for reading (which is explained later, and is hereinafter referred to as the reading light L2). The second transparent conductive layer 5 is transparent to the reading light L2.

For example, the first transparent conductive layer 1 can be suitably formed of noble metal such as platinum, gold, or silver, and the second transparent conductive layer 5 can be suitably realized by films or sheets which are produced by uniformly applying conductive material to a transparent glass plate (e.g., NESA films). Specifically, ITO (In₂O₃:Sn), IZO (In₂O₃:Zn), ATO (SnO₂:Sb), FTO (SnO₂:F), AZO (ZnO:Al), GZO (ZnO:Ga), and the like are sutable for the second transparent conductive layer 5.

In addition, it is more preferable that the charge-transport layer 3 have a greater difference in mobility between the transport polarity charges and the latent-image polarity charges. For example, the following materials (a) to (c) are suitable for the charge-transport layer 3.

(a) Organic materials such as poly (N-vinylcarbazole) (PVK), N,N′-diphenyl-N,N′-bis(3-methylphenyl)-(1,1′-diphenyl)-4,4′-dia mine (TPD), or discotic liquid crystal

(b) Polymers (such as polycarbonate, polystyrene, PVK, or poly(vinyl alcohol)) in which TPD is dispersed

(c) Semiconductor materials such as a-Se doped with 10 to 200 ppm Cl.

(d) As₂Se₃, Sb₂S₃

(e) Silicone oil

(f) Polycarbonate not containing TPD

The above organic compounds (such as PVK, TPD, discotic liquid crystal, silicone oil, or polycarbonate) are particularly preferable for the charge-transport layer 3 since such organic compounds exhibit light insensitivity.

The reading photoconductive layer 4 is formed of inorganic oxide, preferably binary oxide, and more preferably zinc oxide. The thickness of the reading photoconductive layer 4 is 0.3 to 30 micrometers, and preferably 1 to 15 micrometers.

Photoconductive materials which contain, as one or more main components, at least one of a-Se, stabilized a-Se (containing 0.2 to 0.5% As and 10 to 20 ppm Cl), Bi₁₂MO₂₀ (where M is at least one of Ti, Si, and Ge), Bi₄M₃O₁₂ (where M is at least one of Ti, Si, and Ge), Bi₂O₃, BiMO₄ (where M is at least one of Nb, Ta, and V), Bi₂WO₆, Bi₂₄B₂O₃₉, ZnO, ZnS, PbO, HgI₂, PbI₂, CdS, CdSe, CdTe, BiI₃, and the like are preferable for the recording radioconductive layer 2. The thickness of the recording radioconductive layer 2 is 50 to 1,200 micrometers, and preferably 100 to 1,000 micrometers.

Optical Reading System

Hereinbelow, a system for reading an electrostatic latent image by use of light is briefly explained. FIG. 2 schematically shows a recording-and-reading system for recording an electrostatic latent image in the electrostatic recording medium 10 (according to the embodiment) and reading the electrostatic latent image from the electrostatic recording medium 10. That is, both of a system for reading an electrostatic latent image and a system for reading the electrostatic latent image from the electrostatic recording medium 10 are integrated in the recording-and-reading system of FIG. 2.

The recording-and-reading system of FIG. 2 comprises the electrostatic recording medium 10, a recording irradiation unit 90, a power supply 50, a current detecting unit 70, a reading irradiation unit 92, and switches S1 and S2. The power supply 50, the recording irradiation unit 90, and the switch S1 are used for recording an electrostatic latent image in the electrostatic recording medium 10, and the current detecting unit 70 and the switch S2 are used for reading an electrostatic latent image from the electrostatic recording medium 10.

The first transparent conductive layer 1 in the electrostatic recording medium 10 is connected to the negative terminal of the power supply 50 through the switch S1, and to the input terminal of the switch S2. One of the output terminals of the switch S2 is connected to one input terminal of the current detecting unit 70. The other input terminal of the current detecting unit 70, the second transparent conductive layer 5 of the electrostatic recording medium 10, the positive terminal of the power supply 50, and the other of the output terminals of the switch S2 are grounded. The current detecting unit 70 comprises a detection amplifier 70a (realized by an operational amplifier) and a feedback resistor 70b, and realizes a so-called current-to voltage conversion circuit.

A subject (or an object) 9 to be examined is placed above the upper surface of the first transparent conductive layer 1. The subject 9 to be examined includes one or more transparent portions 9a transparent to the radiation L1 (for recording) and one or more (radiation-blocking) portions 9b which block (not transparent to) the radiation L1. The recording irradiation means 90 uniformly irradiates the subject 9 with the radiation L1. The reading irradiation unit 92 scans the solid-state radiographic image detector 10 with the reading light L2 in the direction indicated by the horizontal arrow in FIG. 2. The reading light L2 is, for example, infrared light, electroluminescence (EL), or other light emitted from a light-emitting diode. Preferably, the reading light L2 is converged so as to have a small diameter.

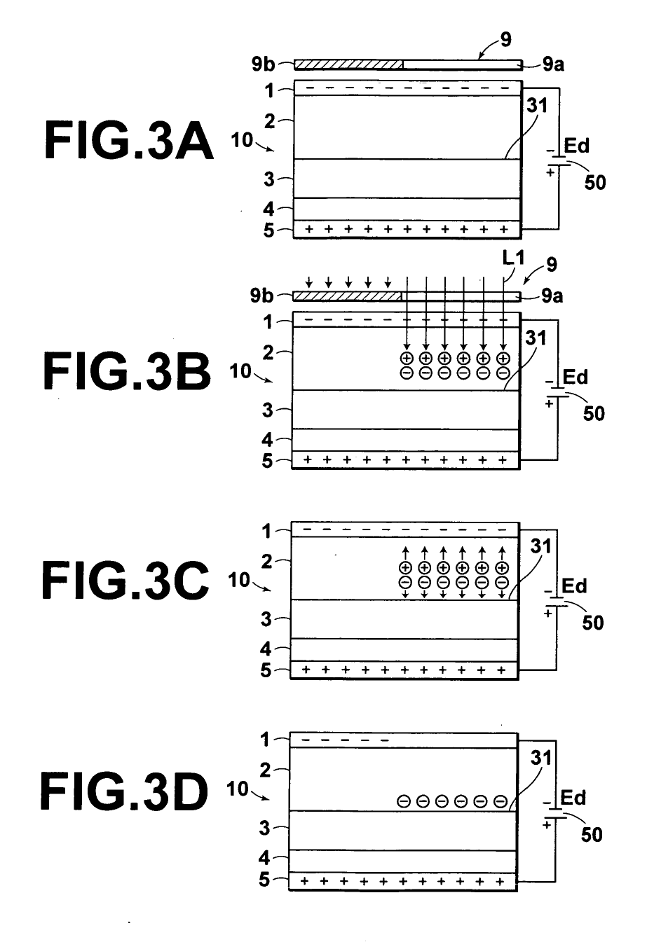

A process of recording an electrostatic latent image in the above recording-and-reading system of FIG. 2 is explained below with reference to FIGS. 3A, 3B, 3C and 3D, which schematically indicate electric charges in respective stages in the process for recording an electrostatic latent image in the recording-and-reading system of FIG. 2.

First, the switch S2 is held opened so that the first transparent conductive layer 1 is connected to neither of the ground and the current detecting unit 70, and the switch S1 is turned on, so that a DC voltage Ed is applied by the power supply 50 between the first and second transparent conductive layers 1 and 5. Thus, the first transparent conductive layer 1 is electrified with negative electric charges from the power supply 50, and the second transparent conductive layer 5 is electrified with positive electric charges from the power supply 50, as illustrated in FIG. 3A, so that a parallel electric field is applied between the first transparent conductive layer 1 and the second transparent conductive layer 5 in the electrostatic recording medium 10.

Next, the recording irradiation unit 90 uniformly irradiates the subject 9 (to be examined) with the radiation L1 (for recording). The radiation L1 passes through the one or more transparent portions 9a of the subject 9 and the first transparent conductive layer 1, so that one or more portions of the recording radioconductive layer 2 are irradiated with the radiation L1, and become conductive. At this time, it is possible to deem each portion of the recording radioconductive layer 2 to behave as a variable resistor which exhibits electric resistance corresponding to the exposure dose of the radiation L1 in the portion of the recording radioconductive layer 2. The electric resistance in each portion of the recording radioconductive layer 2 depends on the amount of pairs of electrons (negative charges) and holes (positive charges) generated by the radiation L1 in the portion of the recording radioconductive layer 2 as illustrated in FIG. 3B. When the exposure dose of the radiation L1 in each portion of the recording radioconductive layer 2 is low, the electric resistance in the portion of the recording radioconductive layer 2 is high. In FIGS. 3B, 3C, and 3D, the encircled symbols “+” indicate the positive charges generated by the radiation L1, and the encircled symbols “−” indicate the negative charges generated by the radiation L1.

The positive charges generated in the recording radioconductive layer 2 move fast through the recording radioconductive layer 2 to the first transparent conductive layer 1, recombine with a portion of the negative charges with which the first transparent conductive layer 1 is electrified, at the interface between the first transparent conductive layer 1 and the recording radioconductive layer 2, and disappear (as illustrated in FIGS. 3C and 3D). On the other hand, the negative charges generated in the recording radioconductive layer 2 move through the recording radioconductive layer 2 to the charge-transport layer 3. Since the charge-transport layer 3 behaves as an insulator against the electric charges of the same polarity as the electric charge with which the first transparent conductive layer 1 is electrified (i.e., the negative charges in this case), the negative charges which have moved through the recording radioconductive layer 2 stop at the interface between the recording radioconductive layer 2 and the charge-transport layer 3, and are accumulated at the interface (as illustrated in FIGS. 3C and 3D). That is, the interface between the recording radioconductive layer 2 and the charge-transport layer 3 realizes a charge-accumulation region 31 as illustrated in FIG. 3D. The amount of the accumulated electric charges is determined by the amount of the negative charges generated in the recording radioconductive layer 2, i.e., the exposure dose of the radiation L1 which has passed through the subject 9.

Alternatively, it is possible to dispense with the charge-transport layer 3. In the case where the electrostatic recording medium 10 does not comprises the charge-transport layer 3, the interface between the recording radioconductive layer 2 and the reading photoconductive layer 4 realizes a charge-accumulation region 31.

In addition, since the radiation L1 does not pass through the one or more (radiation-blocking) portions 9b of the subject 9, no change occurs in the portions of the electrostatic recording medium 10 below the one or more (radiation-blocking) portions 9b (as illustrated in FIGS. 3B to 3D). Therefore, it is possible to accumulate a distribution of electric charges representing an image of the subject 9 by irradiating the subject 9 with the radiation L1, and the image represented by the distribution of electric charges is called the electrostatic latent image.

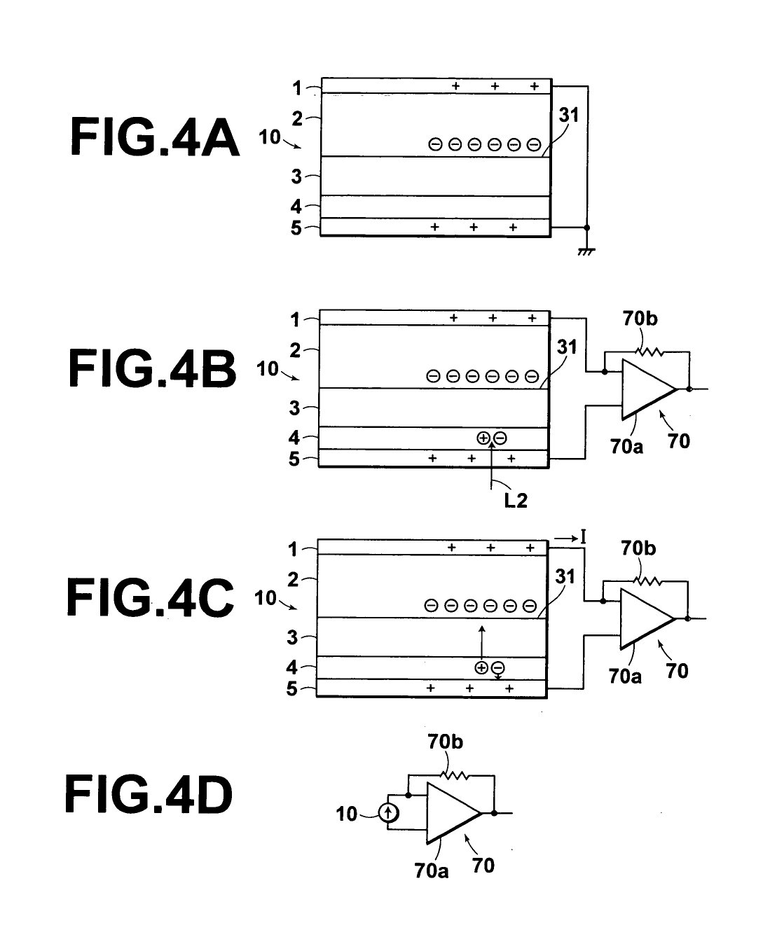

Next, a process of reading an electrostatic latent image in the above recording-and-reading system of FIG. 2 is explained below with reference to FIGS. 4A, 4B, 4C and 4D, which schematically indicate electric charges in respective stages in the process for reading an electrostatic latent image in the recording-and-reading system of FIG. 2.

First, the switch S1 is held open in order to stop the electric power supply, and the switch S2 is turned so as to temporarily ground the first transparent conductive layer 1. Thus, electric charges move between the first transparent conductive layer 1 and the second transparent conductive layer 5 in the electrostatic recording medium 10 in which an electrostatic latent image is recorded, and the electric charges are rearranged so that the first transparent conductive layer 1 and the second transparent conductive layer 5 are held at identical electric potential as illustrated in FIG. 4A. Thereafter, the switch S2 is turned so that the first transparent conductive layer 1 is connected to the one input terminal of the current detecting unit 70 mentioned before.

Then, the second transparent conductive layer side of the electrostatic recording medium 10 is scanned with the reading light L2, so that the reading light L2 passes through the second transparent conductive layer 5, and the scanned portion of the reading photoconductive layer 4 is exposed to the reading light L2. At this time, pairs of electrons (negative charges) and holes (positive charges) are generated in the scanned portion of the reading photoconductive layer 4 by the reading light L2 as illustrated in FIG. 4B, and the generation of pairs of electrons and holes in the scanned portion of the reading photoconductive layer 4 makes the scanned portion of the reading photoconductive layer 4 conductive. In FIGS. 4A, 4B, and 4C, similar to FIGS. 3B, 3C, and 3D, the encircled symbols “+” indicate the positive charges generated by the reading light L2, and the encircled symbols “−” indicate the negative charges generated by the reading light L2.

Since the charge-transport layer 3 behaves as a conductor of the positive charges, when a portion of the reading photoconductive layer 4 is scanned with the reading light L2, and negative electric charges are accumulated right above the scanned portion of the reading photoconductive layer 4 at the interface between the charge-transport layer 3 and the recording radioconductive layer 2, the positive charges generated in the reading photoconductive layer 4 are attracted by the accumulated negative electric charges, and move fast through the charge-transport layer 3 to the interface between the recording radioconductive layer 2 and the charge-transport layer 3 as illustrated in FIG. 4C, so that the positive charges generated in the reading photoconductive layer 4 recombine with the accumulated negative electric charges at the interface, and the positive charges and the accumulated negative electric charges disappear. At the same time, the negative charges generated in the reading photoconductive layer 4 recombine with the positive charges at the second transparent conductive layer 5, and disappear as illustrated in FIG. 4C. The amount of the reading light L2 to which the reading photoconductive layer 4 is exposed is sufficient to generate the amount of positive charges which can recombine with all the accumulated negative electric charges. Therefore, when the entire reading photoconductive layer 4 is scanned with the reading light L2, all the electric charges accumulated at the interface between the charge-transport layer 3 and the recording radioconductive layer 2 vanish. Since the above movement and recombination of the electric charges in the electrostatic recording medium 10 correspond to flow of electric current I through the electrostatic recording medium 10, the arrangement of the electrostatic recording medium 10 and the current detecting unit 70 can be indicated by an equivalent circuit as illustrated in FIG. 4D, where the electrostatic recording medium 10 corresponds to the current source, and the output current of the current source depends on the accumulated electric charges.

As explained above, when the electric current flowing out of the electrostatic recording medium 10 is detected while scanning the reading photoconductive layer 4 with the reading light L2, it is possible to sequentially readout the electric charges accumulated above each portion (corresponding to a pixel) of the reading photoconductive layer 4 in the electrostatic recording medium 10 which is exposed to the reading light L2. Thus, the entire electrostatic latent image can be read out from the electrostatic recording medium 10.

The above operations for detecting a radiation image by using the optical reading system are also disclosed in, for example, U.S. Pat. No. 6,268,614.

### CONCRETE EXAMPLES OF THE PRESENT INVENTION

The present inventor has produced concrete examples of the electrostatic recording medium according to the present invention and a comparison example as indicated below.

### Concrete Example 1

An electrostatic recording medium BTZ-1 has been produced as a concrete example 1 of the electrostatic recording medium according to the present invention in accordance with the following procedure.

A substrate S-1 is produced by forming a layer of FTO (SnO₂:F) and a comb electrode on a glass substrate having the dimensions of 5×5 cm. Then, a layer of ZnO having the thickness of approximately 3 micrometers is formed on the substrate S-1 by high-frequency sputtering during which the substrate temperature is held at 250° C. In the formation of the ZnO layer, the examples disclosed in Japanese Unexamined Patent Publication No. 11-52597 have been referred to. In the sputtering, a film of sintered zinc oxide, formed by applying pressure, is used as a target, where the zinc oxide is prepared in advance by the French process. A sputtering-and-evaporation system is maintained in a vacuum of approximately 10⁻⁵ Pa, and high-purity argon gas and high-purity oxygen gas are supplied to the sputtering-and-evaporation system at the flow-rate ratio of 1:1 and the total flow rate of 15 sccm when the substrate temperature reaches 250° C.

In addition, bismuth oxide (Bi₂O₃) powder and titanium oxide (TiO₂) powder are mixed at the 12.0:1 molar ratio of Bi to Ti, and the mixture further undergoes ball-mill mixing using zirconium oxide balls in ethanol. Thereafter, the mixture is collected, dried, and prebaked at 800° C. for 8 hours, so that solid-phase reaction occurs between the bismuth oxide and the silicon oxide, and Bi₁₂TiO₂₀ (BTO) powder is produced. Subsequently, the Bi₁₂TiO₂₀ powder is coarsely pulverized in a mortar so that the particle diameters of the Bi₁₂TiO₂₀ powder become 150 micrometers or less, and is further pulverized and dispersed in ethanol by use of a ball mill using zirconium oxide balls. At this time, 0.4 weight percent of poly (vinyl butyral) (PVB) is added for promoting the dispersion. Thereafter, 3.7 weight percent of poly(vinyl butyral) (PVB) as a binder and 0.8 weight percent of dioctyl phthalate as a plasticizer are added to the prebaked and pulverized powder of Bi₁₂TiO₂₀, and then the pulverization and mixing in the ball mill are continued so as to produce slurry for forming a sheet. Thereafter, the slurry is collected, and undergoes a vacuum degassing treatment for degassing, concentration, and viscosity adjustment.

Subsequently, the slurry is applied to a film base by using a coater so that the slurry is shaped into a sheet. Before the application of the slurry, a releasing agent is applied to the film base. Next, the slurry applied to the film base is dried by leaving it at room temperature for 24 hours, and is then stripped from the film base. Thereafter, the sheet stripped from the film base is placed on a single crystal of sapphire, and sintered at 850° C. in an Ar atmosphere. Thus, a sheet BT-1 of sintered Bi₁₂TiO₂₀ having a thickness of approximately 200 micrometers is obtained.

Thereafter, a layer of polycarbonate is formed on the layer of ZnO by application, and then the polycarbonate layer is joined to a surface of the sheet BT-1 of sintered Bi₁₂TiO₂₀. Finally, an upper electrode of gold having a thickness of 60 nm is formed on the opposite (exposed) surface of the sheet BT-1 of sintered Bi₂TiO₂₀ by sputtering. Thus, the electrostatic recording medium BTZ-1 is obtained.

### Concrete Example 2

An electrostatic recording medium BTZ-2 has been produced as a concrete example 2 of the electrostatic recording medium according to the present invention in accordance with the following procedure.

A layer of ZnO having the thickness of approximately 3 micrometers is formed on the substrate S-1 (produced during the process for producing the electrostatic recording medium BTZ-1 as the concrete example 1) by repeating a film-forming operation using spray thermal decomposition with zinc nitrate solution. The film-forming operation is performed in a mixed atmosphere of oxygen and argon, and the substrate temperature is held at 300° C. during the film-forming operation. In the formation of the ZnO layer, the example 4 in Japanese Unexamined Patent Publication No. 2000-227670 has been referred to.

Thereafter, a layer of polycarbonate is formed on the above layer of ZnO by application, and then the polycarbonate layer is joined to a surface of the sheet BT-1 of sintered Bi₁₂TiO₂₀ (produced during the process for producing the electrostatic recording medium BTZ-1 as the concrete example 1). Finally, an upper electrode of gold having a thickness of 60 nm is formed on the opposite (exposed) surface of the sheet BT-1 of sintered Bi₁₂TiO₂₀ by sputtering. Thus, the electrostatic recording medium BTZ-2 is obtained.

### Concrete Example 3

An electrostatic recording medium BTZ-3 has been produced as a concrete example 3 of the electrostatic recording medium according to the present invention in accordance with the following procedure.

A layer of ZnO having the thickness of approximately 3 micrometers is formed on the substrate S-1 (produced during the process for producing the electrostatic recording medium BTZ-1 as the concrete example 1) by the sol-gel process. In the process for forming the layer of ZnO, the example 4 in Japanese Unexamined Patent Publication No. 2000-227670 has been referred to, and spin-coat application, onto the substrate S-1, of a water solution of diethanolamine containing zinc chloride and baking at 450° C. are repeated.

Thereafter, a layer of polycarbonate is formed on the above layer of ZnO by application, and then the polycarbonate layer is joined to a surface of the sheet BT-1 of sintered Bi₁₂TiO₂₀ (produced during the process for producing the electrostatic recording medium BTZ-1 as the concrete example 1). Finally, an upper electrode of gold having a thickness of 60 nm is formed on the opposite (exposed) surface of the sheet BT-1 of sintered Bi₁₂TiO₂₀ by sputtering. Thus, the electrostatic recording medium BTZ-3 is obtained.

### Concrete Example 4

An electrostatic recording medium BTZ-4 has been produced as a concrete example 4 of the electrostatic recording medium according to the present invention in accordance with the following procedure.

A slurry solution of zinc oxide in which zinc oxide (ZnO) particles of the purity of 5N (five nines) and the dimensions of 1 micrometer are dispersed in a solution of 30 weight percent polyethylene glycol (the molecular weight of which is 500,000) is prepared, and a porous film of ZnO having the thickness of approximately 5 micrometers is formed on the substrate S-1 (produced during the process for producing the electrostatic recording medium BTZ-1 as the concrete example 1) by applying the slurry solution of zinc oxide onto the substrate S-1 by the doctor blade process and baking the substrate S-1 at 450° C. for one hour. The above zinc oxide particles of the purity of 5N (five nines) are manufactured by Kojundo Chemical Lab. Co., Ltd. (Japan).

Thereafter, a layer of polycarbonate is formed on the above porous film of ZnO by application, and then the polycarbonate layer is joined to a surface of the sheet BT-1 of sintered Bi₂TiO₂₀ (produced during the process for producing the electrostatic recording medium BTZ-1 as the concrete example 1). Finally, an upper electrode of gold having a thickness of 60 nm is formed on the opposite (exposed) surface of the sheet BT-1 of sintered Bi₁₂TiO₂₀ by sputtering. Thus, the electrostatic recording medium BTZ-4 is obtained.

### Concrete Example 5

An electrostatic recording medium BTZ-5 has been produced as a concrete example 5 of the electrostatic recording medium according to the present invention in accordance with a procedure which is different from the procedure used in the production of the concrete example 4 only in that the layer of polycarbonate is replaced with a layer of silicone oil.

### Concrete Example 6

An electrostatic recording medium BTZ-6 has been produced as a concrete example 6 of the electrostatic recording medium according to the present invention in accordance with the following procedure.

A substrate S-2 is produced by forming a layer of IZO (In₂O₃:Zn) and a comb electrode on a glass substrate. In addition, a slurry solution of zinc oxide is prepared. In the slurry solution of zinc oxide, zinc oxide (ZnO) particles having cubic shapes and the dimensions of 1 micrometer are dispersed in a solution of polyester resin (Vylon, manufactured by Toyobo Co., Ltd., Japan) at the weight ratio of 50%. The above zinc oxide (ZnO) particles are produced by the French process. Further, a layer of polycarbonate is formed, by application, on a surface of the sheet BT-1 of sintered Bi₁₂TiO₂₀ (produced during the process for producing the electrostatic recording medium BTZ-1 as the concrete example 1).

Thereafter, the above slurry solution of zinc oxide is applied onto the above layer of polycarbonate on the sheet BT-1 of sintered Bi₁₂TiO₂₀ by the doctor blade process so as to form a film of zinc oxide having a thickness of 6 micrometers on the layer of polycarbonate. After the film of zinc oxide is dried, a solution of 1% poly(vinyl alcohol) (PVA 205, manufactured by Kuraray Co., Ltd., Japan) is applied onto the film of zinc oxide, and concentrated. Thereafter, the film of zinc oxide is joined to the substrate S-2 with the concentrated solution of poly(vinyl alcohol). Finally, an upper electrode of gold having a thickness of 60 nm is formed on the opposite (exposed) surface of the sheet BT-1 of sintered Bi₁₂TiO₂₀ by sputtering. Thus, the electrostatic recording medium BTZ-6 is obtained.

### Concrete Example 7

An electrostatic recording medium BTZ-7 has been produced as a concrete example 7 of the electrostatic recording medium according to the present invention in accordance with the following procedure.

A slurry solution of zinc oxide is prepared. In the slurry solution, zinc oxide (ZnO) particles having cubic shapes and the dimensions of 1 micrometer are dispersed in a solution of polyester resin (Vylon, manufactured by Toyobo Co., Ltd., Japan) at the weight ratio of 50%. The above zinc oxide (ZnO) particles are produced by the French process. Then, the above slurry solution of zinc oxide is applied onto the substrate S-2 (produced during the process for producing the electrostatic recording medium BTZ-6 as the concrete example 6) by the doctor blade process so as to form a film of zinc oxide having a thickness of 6 micrometers on the substrate S-2. Subsequently, a layer of polycarbonate is formed on the film of zinc oxide by application, and is joined to a surface of the sheet BT-1 of sintered Bi₁₂TiO₂₀ (produced during the process for producing the electrostatic recording medium BTZ-1 as the concrete example 1). Finally, an upper electrode of gold having a thickness of 60 nm is formed on the opposite (exposed) surface of the sheet BT-1 of sintered Bi₁₂TiO₂₀ by sputtering. Thus, the electrostatic recording medium BTZ-7 is obtained.

### Concrete Example 8

An electrostatic recording medium BTZ-8 has been produced as a concrete example 8 of the electrostatic recording medium according to the present invention in accordance with the following procedure.

A liter of a water solution containing 0.25 mole/liter of zinc chloride of the purity of 5N (manufactured by Kojundo Chemical Lab. Co., Ltd., Japan) and a liter of a water solution containing 0.3 mole/liter of 2-amino ethanol are mixed, and the mixture is heated at 90° C. for one hour while being agitated, so that zinc hydroxy chloride precipitates. Then, the zinc hydroxy chloride is obtained by solid-liquid separation and filtration, washed with water and ethanol, and dried at 120° C. for two hours. Thereafter, the temperature is raised to 850° C. at the temperature raising rate of 10° C./minute, and the zinc hydroxy chloride is baked for 30 minutes, so that 24 grams of oriented flakelike ZnO particles (having the diameters of 0.3 micrometers and the thicknesss of 0.02 micrometers) are obtained.

Next, a slurry solution of zinc oxide is prepared. In the slurry solution, the above ZnO particles are dispersed in a solution of polyester resin (Vylon, manufactured by Toyobo Co., Ltd., Japan) at the weight ratio of 50%. In addition, a layer of polycarbonate is formed on a surface of the the sheet BT-1 of sintered Bi₁₂TiO₂₀ by application (where the sheet BT-1 is produced during the process for producing the electrostatic recording medium BTZ-1 as the concrete example 1).

The above slurry solution of zinc oxide is applied onto the layer of polycarbonate by the doctor blade process so as to form a film of zinc oxide having a thickness of 6 micrometers on the layer of polycarbonate. After the film of zinc oxide is dried, a solution of 1% poly(vinyl alcohol) (PVA 205, manufactured by Kuraray Co., Ltd., Japan) is applied onto the film of zinc oxide, and concentrated. Thereafter, the film of zinc oxide is joined to the substrate S-2 with the concentrated solution of poly(vinyl alcohol). Finally, an upper electrode of gold having a thickness of 60 nm is formed on the opposite (exposed) surface of the sheet BT-1 of sintered Bi₁₂TiO₂₀ by sputtering. Thus, the electrostatic recording medium BTZ-8 is obtained.

### Concrete Example 9

An electrostatic recording medium BTZ-9 has been produced as a concrete example 9 of the electrostatic recording medium according to the present invention in accordance with the following procedure.

The porous film of ZnO (produced during the process for producing the electrostatic recording medium BTZ-4 as the concrete example 4) is soaked in a solution of metal-free phthalocyanine for the purpose of spectral sensitization. Thereafter, a layer of polycarbonate is formed on the porous film of ZnO, and the layer of polycarbonate is joined to a surface of the sheet BT-1 of sintered Bi₁₂TiO₂₀ (produced during the process for producing the electrostatic recording medium BTZ-1 as the concrete example 1). Finally, an upper electrode of gold having a thickness of 60 nm is formed on the opposite (exposed) surface of the sheet BT-1 of sintered Bi₁₂TiO₂₀ by sputtering. Thus, the electrostatic recording medium BTZ-9 is obtained.

### Concrete Example 10

An electrostatic recording medium BTZ-10 has been produced as a concrete example 10 of the electrostatic recording medium according to the present invention in accordance with the following procedure.

The porous film of ZnO (produced during the process for producing the electrostatic recording medium BTZ-4 as the concrete example 4) is soaked in a solution of eosin Y for the purpose of spectral sensitization. Thereafter, a layer of polycarbonate is formed on the porous film of ZnO, and the layer of polycarbonate is joined to a surface of the sheet BT-1 of sintered Bi₂TiO₂₀ (produced during the process for producing the electrostatic recording medium BTZ-1 as the concrete example 1). Finally, an upper electrode of gold having a thickness of 60 nm is formed on the opposite (exposed) surface of the sheet BT-1 of sintered Bi₁₂TiO₂₀ by sputtering. Thus, the electrostatic recording medium BTZ-10 is obtained.

### Concrete Example 11

An electrostatic recording medium BTZ-11 has been produced as a concrete example 11 of the electrostatic recording medium according to the present invention in accordance with the following procedure.

The porous film of ZnO (produced during the process for producing the electrostatic recording medium BTZ-4 as the concrete example 4) is soaked in a solution of rose bengal for the purpose of spectral sensitization. Thereafter, a layer of polycarbonate is formed on the porous film of ZnO, and the layer of polycarbonate is joined to a surface of the sheet BT-1 of sintered Bi₁₂TiO₂₀ (produced during the process for producing the electrostatic recording medium BTZ-1 as the concrete example 1). Finally, an upper electrode of gold having a thickness of 60 nm is formed on the opposite (exposed) surface of the sheet BT-1 of sintered Bi₁₂TiO₂₀ by sputtering. Thus, the electrostatic recording medium BTZ-11 is obtained.

### Concrete Example 12

An electrostatic recording medium BTZ-12 has been produced as a concrete example 12 of the electrostatic recording medium according to the present invention in accordance with a procedure which is different from the procedure used in the production of the concrete example 8 only in that eosin Y is added to the slurry solution of zinc oxide.

### Concrete Example 13

An electrostatic recording medium ZZ-13 has been produced as a concrete example 13 of the electrostatic recording medium according to the present invention in accordance with a procedure which is different from the procedure used in the production of the concrete example 10 only in the recording radioconductive layer 2. The recording radioconductive layer 2 in the concrete example 13 is a sheet of sintered ZnO, instead of the sheet of the sintered Bi₁₂TiO₂₀. The manner of preparation of the recording radioconductive layer 2 in the concrete example 13 is different from the manner of preparation of the sheet BT-1 of sintered Bi₁₂TiO₂₀ (produced during the process for producing the electrostatic recording medium BTZ-1 as the concrete example 1) only in that ZnO powder of the purity of 5N (manufactured by Kojundo Chemical Lab. Co., Ltd., Japan) is used instead of the Bi₁₂TiO₂₀ powder obtained by the prebaking of the mixture of the bismuth oxide (Bi₂O₃) powder and titanium oxide (TiO₂) powder, poly(vinyl alcohol), instead of the poly(vinyl butyral) (PVB), is used as a binder, the sintering temperature is 1,250° C., and the thickness of the finally obtained sheet of sintered ZnO is 700 micrometers.

### Concrete Example 14

An electrostatic recording medium BTT-14 has been produced as a concrete example 14 of the electrostatic recording medium according to the present invention in accordance with a procedure which is different from the procedure used in the production of the concrete example 10 only in that the sluury solution of ZnO is prepared by use of the TiO₂ suspension manufactured by Solaronix SA.

### Concrete Example 15

An electrostatic recording medium BTI-15 has been produced as a concrete example 15 of the electrostatic recording medium according to the present invention in accordance with a procedure which is different from the procedure used in the production of the concrete example 10 only in that particles of indium oxide (In₂O₃) having the purity of 5N (manufactured by Kojundo Chemical Lab. Co., Ltd., Japan) are used instead of the zinc oxide (ZnO) particles.

### Concrete Example 16

An electrostatic recording medium BTN-16 has been produced as a concrete example 16 of the electrostatic recording medium according to the present invention in accordance with a procedure which is different from the procedure used in the production of the concrete example 10 only in that particles of niobium (V) oxide (Nb₂O₅) having the purity of 4N (manufactured by Kojundo Chemical Lab. Co., Ltd., Japan) are used instead of the zinc oxide (ZnO) particles.

### Concrete Example 17

An electrostatic recording medium BTS-17 has been produced as a concrete example 17 of the electrostatic recording medium according to the present invention in accordance with a procedure which is different from the procedure used in the production of the concrete example 10 only in that particles of tin (IV) oxide (SnO₂) having the purity of 4N (manufactured by Kojundo Chemical Lab. Co., Ltd., Japan) are used instead of the zinc oxide (ZnO) particles.

### Concrete Example 18

An electrostatic recording medium BTB-18 has been produced as a concrete example 18 of the electrostatic recording medium according to the present invention in accordance with a procedure which is different from the procedure used in the production of the concrete example 10 only in that particles of bismuth oxide (Bi₂O₃) having the purity of 6N (manufactured by Kojundo Chemical Lab. Co., Ltd., Japan) are used instead of the zinc oxide (ZnO) particles.

### Comparison Example 1

An electrostatic recording medium BTS-1 has been produced as a comparison example 1 of the electrostatic recording medium in accordance with the following procedure.

A layer of 0.35 percent arsenic-doped amorphous selenium having a thickness of 10 micrometers is formed on the substrate S-2 (produced during the process for producing the electrostatic recording medium BTZ-6 as the concrete example 6) by evaporation, and a layer of silicone oil is formed on the layer of As-doped a-Se by application. Then, the layer of silicone oil is joined to a surface of the sheet BT-1 of sintered Bi₁₂TiO₂₀ (produced during the process for producing the electrostatic recording medium BTZ-1 as the concrete example 1). Finally, an upper electrode of gold having a thickness of 60 nm is formed on the opposite (exposed) surface of the sheet BT-1 of sintered Bi₁₂TiO₂₀ by sputtering. Thus, the electrostatic recording medium BTS-1 is obtained.

The structures of the above examples of electrostatic recording mediums are summarized in Table 1.

TABLE 1

| | | | | | Recording | |
|---|---|---|---|---|---|---|
| | | | Reading Photoconductive | | Radioconductive | |
| | Device Name | 5 | Layer 4 | 3 | Layer 2 | Joint |
| E1 | BTZ-1 | FTO | ZnO Film by Sputtering | P | Sintered BTO | 2-3 |
| | | | | | Film | |
| E2 | BTZ-2 | FTO | ZnO Film by Spray Thermal | P | Sintered | 2-3 |
| | | | Decomposition | | BTO Film | |
| E3 | BTZ-3 | FTO | ZnO Film by Sol-Gel Process | P | Sintered | 2-3 |
| | | | | | BTO Film | |
| E4 | BTZ-4 | FTO | Sintered Porous ZnO Film | P | Sintered | 2-3 |
| | | | | | BTO Film | |
| E5 | BTZ-5 | FTO | Sintered Porous ZnO Film | S | Sintered | 2-3 |
| | | | | | BTO Film | |
| E6 | BTZ-6 | IZO | Film of Dispersed ZnO | P | Sintered | 4-5 |
| | | | Particles (French Process) | | BTO Film | PVA |
| E7 | BTZ-7 | IZO | Film of Dispersed ZnO | P | Sintered | 2-3 |
| | | | Particles (French Process) | | BTO Film | |
| E8 | BTZ-8 | IZO | Film of ZnO Particles | P | Sintered | 4-5 |
| | | | Dispersed along [001] | | BTO Film | PVA |
| | | | Principal Plane | | | |
| E9 | BTZ-9 | FTO | Sintered Porous ZnO Film | S | Sintered | 2-3 |
| | | | Sensitized with Metal-Free | | BTO Film | |
| | | | Phthalocyanine | | | |
| E10 | BTZ-10 | FTO | Sintered Porous ZnO Film | S | Sintered | 2-3 |
| | | | Sensitized with Eosin | | BTO Film | |
| E11 | BTZ-11 | FTO | Sintered Porous ZnO Film | S | Sintered | 2-3 |
| | | | Sensitized with Rose Bengal | | BTO Film | |
| E12 | BTZ4-5 | IZO | Film of ZnO Particles | P | Sintered | 4-5 |
| | | | Dispersed along [001] | | BTO Film | PVA |
| | | | Principal Plane and | | | |
| | | | Sensitized with Eosin | | | |
| E13 | ZZ-13 | FTO | Sintered Porous ZnO Film | S | Sintered | 2-3 |
| | | | Sensitized with Eosin | | ZnO Film | |
| E14 | BTT-14 | FTO | Sintered Porous TiO₂ Film | S | Sintered | 2-3 |
| | | | Sensitized with Eosin | | BTO Film | |
| E15 | BTI-15 | FTO | Sintered Porous In₂O₃ Film | S | Sintered | 2-3 |
| | | | Sensitized with Eosin | | BTO Film | |
| E16 | BTN-16 | FTO | Sintered Porous Nb₂O₅ Film | S | Sintered | 2-3 |
| | | | Sensitized with Eosin | | BTO Film | |
| E17 | BTS-17 | FTO | Sintered Porous SnO₂ Film | S | Sintered | 2-3 |
| | | | Sensitized with Eosin | | BTO Film | |
| E18 | BTB-18 | FTO | Sintered Porous Bi₂O₃ Film | S | Sintered | 2-3 |
| | | | Sensitized with Eosin | | BTO Film | |
| CP1 | BTS-1 | IZO | Se Film | S | Sintered | 2-3 |
| | | | | | BTO Film | |

The abbreviations used in Table 1
E1 to E18: the concrete examples 1 to 18
CP1: the comparison example 1
1: the first transparent conductive layer 1
3: the charge-transport layer 3
P: polycarbonate
S: silicone oil
2-3: joint between the recording radioconductive layer 2 and the charge-transport layer 3
4-5: joint between the reading photoconductive layer 4 and the second transparent conductive layer 5

Comparison of Performance

In order to evaluate the performance of the concrete examples 1 to 18 of the present invention and the comparison example 1 produced as above, the present inventor has arranged an image reading system as disclosed in U.S. Patent Application Publication No. 20040086204, although the planar reading-light source used in the disclosed system is not used, and instead a linear light source in which LEDs are linearly arrayed is mechanically moved for scanning each electrostatic recording medium. The present inventor has measured the sharpness of an image detected by use of each of the electrostatic recording mediums as the concrete examples 1 to 18 and the comparison example 1. In the measurement, the high-speed (fast) reading mode as disclosed in U.S. Patent Application Publication No. 20040086204 is used, and the wavelength of the LEDs constituting the linear light source is 385 nm for the electrostatic recording mediums BTZ-1 to BTZ-8, 480 nm for the electrostatic recording mediums BTZ-9, BTZ-10, BTZ-12, ZZ-13, BTT-14, BTI-15, BTN-16, BTS-17, BTB-18, and BTS-1, and 563 nm for the electrostatic recording medium BTZ-11.

According to the above measurement, the present inventor has confirmed that the electrostatic recording mediums as the concrete examples 1 to 18 of the present invention achieve satisfactory sharpness, while the comparison example 1 does not achieve satisfactory sharpness.

All of the contents of the Japanese patent application No. 2005-185110 are incorporated into this specification by reference.

What is claimed is:

1. An electrostatic recording medium for recording an electrostatic latent image, comprising:
a first conductive layer which is transparent to radiation for recording;
a recording-side photoconductive layer which is formed above said first conductive layer and becomes conductive when the recording-side photoconductive layer is exposed to said radiation for recording;
a charge-accumulation region which is formed above said recording-side photoconductive layer and accumulates electric charges being generated in said recording-side photoconductive layer and having a latent polarity;
a reading-side photoconductive layer which is formed of inorganic oxide above said charge-accumulation region and becomes conductive when the reading-side photoconductive layer is exposed to an electromagnetic wave for reading; and
a second conductive layer which is formed above said reading-side photoconductive layer and transparent to said electromagnetic wave for reading.

2. An electrostatic recording medium according to claim 1, wherein said inorganic oxide is binary oxide.

3. An electrostatic recording medium according to claim 2, wherein said binary oxide is zinc oxide.

4. An electrostatic recording medium according to claim 1, wherein said inorganic oxide is dye-sensitized.

5. An electrostatic recording medium according to claim 2, wherein said inorganic oxide is dye-sensitized.

6. An electrostatic recording medium according to claim 3, wherein said inorganic oxide is dye-sensitized.
